(19) United States
(12) Patent Application Publication
(10) Pub. No.: US 2025/0231755 A1
(43) Pub. Date: Jul. 17, 2025

(54) BMC HETEROGENOUS UPGRADING METHOD AND SYSTEM, DEVICE, AND READABLE STORAGE MEDIUM

(71) Applicant: SUZHOU METABRAIN INTELLIGENT TECHNOLOGY CO., LTD., Suzhou, Jiangsu (CN)

(72) Inventor: Zhongzhan TIAN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/850,550

(22) PCT Filed: Aug. 30, 2023
(86) PCT No.: PCT/CN2023/115971

§ 371 Date: Sep. 24, 2024

(30) Foreign Application Priority Data
Nov. 30, 2022 (CN) 202211516606.1

(51) Int. Cl. G06F 8/61; G06F 8/65; G06F 8/71; G06F 11/14

(52) U.S. Cl. CPC G06F 8/63; G06F 8/65; G06F 8/71; G06F 11/1438

(57) ABSTRACT

Disclosed are a BMC heterogeneous upgrading method and system, a device, and a non-transitory readable storage medium. The method includes: a target image installation program is generated based on an installation method of a target image, and the target image installation program is sent to a target device; and in response to the execution of the target image installation program, the target image is sent to the target device, and the target image is installed onto the target device through the target image installation program.

### CROSS-REFERENCE TO RELATED DISCLOSURE

The present application is a National Stage Application of PCT International Application No.: PCT/CN2023/115971 filed on Aug. 30, 2023, which claims priority to Chinese Patent Application 202211516606.1, filed in the China National Intellectual Property Administration on Nov. 30, 2022, the disclosure of which is incorporated herein by reference in its entirety.

### TECHNICAL FIELD

This disclosure belongs to the field of computers, and specifically relates to a BMC heterogeneous upgrading method and system, a device, and a readable storage medium.

### BACKGROUND

With the development of society, informatization is gradually covering various fields of society. The daily lives of people are increasingly dependent on information and data, especially with the development of cloud computing, big data, and artificial intelligence (AI), which provide people with a large number of intelligent services or computing services. Servers, as a carrier of data processing and storage, are applied to a large scale, and play an increasingly important role. Moreover, with the increasing demand from the business market and the application market, the computing power, the storage capacity, etc. of the servers are constantly evolving, and new technologies are emerging rapidly. Therefore, there are inevitably some inconveniences when applying new technologies to some old servers. For example, the problems arise during the update and iteration of OpenBMC and baseboard management controller (BMC) technologies. The BMC is a baseboard management controller on the server and is an early version of a BMC firmware unit. With technology iteration and the improvement of existing server specifications, a better baseboard management control solution has emerged, namely OpenBMC. The emergence and source opening of the OpenBMC (based on the open-source baseboard management controller) have prompted many manufacturers to start the transition from the BMC to the OpenBMC to enhance the management capabilities of the server, which is an improvement of service quality of the functions for customers by the manufacturers.

However, there are some problems in the transition process. The biggest problem is how to upgrade the running BMC to the OpenBMC. Since most servers requiring the upgrade from the BMC are generally servers sold by the manufacturers, the upgrade from the BMC to the OpenBMC cannot be completed by a conventional BMC upgrading method while the server is operating, or when the conventional BMC on the server is operating, the OpenBMC cannot be installed because the BMC (referring to the system when BMC is running) does not support the installation of the OpenBMC. Therefore, in most scenarios, the upgrade either requires returning the server to the manufacturer for a worker to re-burn the new OpenBMC, or the manufacturer will dispatch a corresponding worker to a computer room of the customer to re-burn the new OpenBMC firmware for the server purchased by the customer. However, all of the above methods bring great inconvenience because the conventional BMC does not support the upgrade to the OpenBMC.

### SUMMARY

To solve the above problems, this disclosure provides a BMC heterogeneous upgrading method, including:
a target image installation program is generated based on an installation method of a target image, and the target image installation program is sent to a target device; and
in response to the execution of the target image installation program, the target image is sent to the target device, and the target image is installed onto the target device through the target image installation program.

In some implementations of this disclosure, the target image installation program is generated based on an installation method of a target image, and the target image installation program is sent to a target device includes:
based on a current image of the target device, the target image installation program is embedded into the current image to generate a temporary image; and
the temporary image is sent to the target device and the temporary image is installed onto the target device through an image system currently running on the target device.

In some implementations of this disclosure, in response to the execution of the target image installation program, the target image is sent to the target device includes:
based on a file format of the current image, a file format of the target image is packaged into the same file format as the current image, and a packaged target image file is sent to the target device.

In some implementations of this disclosure, the target image is installed onto the target device through the target image installation program includes:
based on the file format of the current image, the received image file is parsed through the target image installation program to obtain an identification code and a core file, and it is confirmed that the target image is correct through the identification code; and
in response to confirming that the version of the target image file is not the target image based on the identification code, the target image is installed based on an installation method of the current image.

In some implementations of this disclosure, the method further includes:
in response to confirming that the version of the image file is the target image based on the identification code, the core file is converted into a predetermined format used by the current image, and the converted core file and other files in the target image are written into a main memory and/or a backup memory based on a write method of the current image.

In some implementations of this disclosure, the method further includes:
in response to confirming that the version of the image file is the target image based on the identification code, the size of the target image is modified to a predetermined value before writing the target image.

In some implementations of this disclosure, the method further includes:
in response to the completion of writing the target image into the memory, the target device is rebooted and a predetermined register is set, such that the target device loads both a boot program and a kernel program of the target image from the same memory.

In some implementations of this disclosure, the method further includes:
a running status of the boot program and the kernel program are monitored, and in response to abnormal operation of the boot program and/or the kernel program, and the memory that stores the image is switched to reboot the target device after waiting for a predetermined time.

In some implementations of this disclosure, the method further includes:
in response to the image system of the target device being the target image and an image to be installed being the current image, the current image is created in a compressed format using a first predetermined method, the current image in the compressed format is written to the backup memory through the target image, and an image loading path of the target device is switched to the backup memory to reboot the target device.

In some implementations of this disclosure, the method further includes:
in response to the target device booting from the backup memory, the current image is written in the backup memory to the main memory through a rollback function.

Another aspect of this disclosure further provides a BMC heterogeneous upgrading system, including:
an initialization module, configured to generate a target image installation program based on an installation method of a target image, and send the target image installation program to a target device; and
an execution module, configured to send, in response to the execution of the target image installation program, the target image to the target device, and install the target image onto the target device through the target image installation program.

In some implementations of this disclosure, the initialization module is configured to:
embed, based on a current image of the target device, the target image installation program into the current image to generate a temporary image; and
send the temporary image to the target device and install the temporary image onto the target device through an image system currently running on the target device.

In some implementations of this disclosure, the execution module is configured to:
package, based on a file format of the current image, a file format of the target image into the same file format as the current image, and send a packaged target image file to the target device.

In some implementations of this disclosure, the execution module is configured to:
parse, based on the file format of the current image, the received image file through the target image installation program to obtain an identification code and a core file, and confirm that the target image is correct through the identification code; and
install, in response to confirming that the version of the target image file is not the target image based on the identification code, the target image based on an installation method of the current image.

In some implementations of this disclosure, the execution module is configured to:
convert, in response to confirming that the version of the image file is the target image based on the identification code, the core file into a predetermined format used by the current image, and write the converted core file and other files in the target image into a main memory and/or a backup memory based on a write method of the current image.

In some implementations of this disclosure, the execution module is configured to:
modify, in response to confirming that the version of the image file is the target image based on the identification code, the size of the target image to a predetermined value before writing the target image.

In some implementations of this disclosure, the execution module is configured to:
reboot, in response to the completion of writing the target image into the memory, the target device and set a predetermined register, such that the target device loads both a boot program and a kernel program of the target image from the same memory.

In some implementations of this disclosure, the execution module is configured to:
monitor a running status of the boot program and the kernel program, and in response to abnormal operation of the boot program and/or the kernel program, switch the memory that stores the image to reboot the target device after waiting for a predetermined time.

In some implementations of this disclosure, the execution module is configured to:
create, in response to the image system of the target device being the target image and an image to be installed being the current image, the current image in a compressed format using a first predetermined method, write the current image in the compressed format to the backup memory through the target image, and switch an image loading path of the target device to the backup memory to reboot the target device.

In some implementations of this disclosure, the execution module is configured to:
write, in response to the target device booting from the backup memory, the current image in the backup memory to the main memory through a rollback function.

Another aspect of this disclosure further provides a computer device, including:
at least one processor; and
a memory, where the memory stores computer instructions executable on the processor, and the instructions, when executed by the processor, implement the steps of the method according to any one of the above implementations.

Another aspect of this disclosure further provides a non-transitory computer readable storage medium. The non-transitory computer readable storage medium stores a computer program, and the computer program, when executed by a processor, implements the steps of the method according to any one of the above implementations.

According to the BMC heterogeneous upgrading method provided by this disclosure, the corresponding installation program is generated based on an installation method of an OpenBMC, an installation program for installing the OpenBMC is implanted into a BMC image as a new image, and the current image on the BMC is replaced with the new image, thereby allowing a conventional BMC to support installation of an OpenBMC image. The BMC image is upgraded in reverse through an upgrade interface of the OpenBMC, thereby achieving a heterogeneous upgrade between the BMC and the OpenBMC, and implementing remote upgrades from the BMC to the OpenBMC for a large number of servers. The problem that the efficiency is low during the upgrade from the BMC to the OpenBMC currently is solved.

### BRIEF DESCRIPTION OF THE DRAWINGS

In order to describe technical solutions in embodiments of this disclosure or in the prior art more clearly, accompanying drawings required to be used in descriptions of the embodiments or the prior art will be briefly introduced below, it is apparent that the accompanying drawings described below are only some embodiments of this disclosure, and those of ordinary skill in the art may also obtain other accompanying drawings according to these accompanying drawings without creative work.

FIG. 1 is a schematic flowchart of a BMC heterogeneous upgrading method according to an embodiment of this disclosure;

FIG. 2 is a structural schematic diagram of a BMC heterogeneous upgrading system according to an embodiment of this disclosure;

FIG. 3 is a schematic structural diagram of a computer device according to an embodiment of this disclosure; and

FIG. 4 is a structural schematic diagram of a non-transitory computer readable storage medium according to an embodiment of this disclosure.

### DETAILED DESCRIPTION OF THE EMBODIMENTS

To have a more clear understanding of objectives, technical solutions, and advantages of this disclosure, the embodiments of this disclosure are further described in detail in conjunction with specific embodiments and with reference to the accompanying drawings below.

This disclosure aims to solve the problem of inconvenience existing when upgrading a BMC on a server to an OpenBMC. A conventional BMC has a version iteration function, that is, a BMC image may be remotely uploaded to the BMC, and then, the BMC writes the BMC image into a Flash based on a conventional upgrading method to complete iterative update of the BMC. However, a conventional BMC system cannot achieve an upgrade to the OpenMBC based on a BMC upgrading method. Typically, the BMC is upgraded by connecting a corresponding burning tool to the Flash of the BMC, and then burning the OpenBMC into the Flash, which inevitably needs to be completed by returning the server to a manufacturer or requiring the manufacturer to dispatch an engineer to a data center. As a result, due to the problem about costs associated with personnel mobilization or returning the server to the manufacturer, many manufacturers or server users lack enthusiasm for upgrading to the OpenBMC. For the customers using the server, they are unable to use better server management services. To use better management services, the server needs to be immediately replaced with a new type, which results in increased costs due to early server device iterations. For the manufacturers, they are unable to provide the customers with a better baseboard management function. However, solving the above problems undoubtedly enhances the service quality of the manufacturers and makes products more competitive.

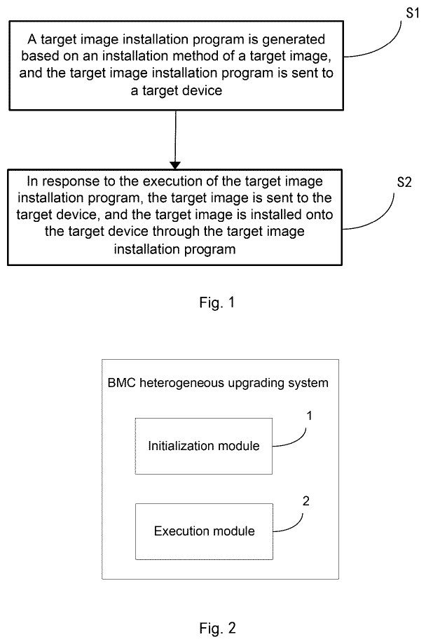

As shown in FIG. 1, to solve the above problems, this disclosure provides a BMC heterogeneous upgrading method, including:
Step S1: a target image installation program is generated based on an installation method of a target image, and the target image installation program is sent to a target device.
Step S2: in response to the execution of the target image installation program, the target image is sent to the target device, and the target image is installed onto the target device through the target image installation program.

In this embodiment of this disclosure, in step S1, the target device is a BMC device running a conventional BMC system. The so-called target image is an OpenBMC image, which is a firmware program to be installed on a BMC or an embedded operating system. Since the conventional BMC system does not support an installation method of the OpenBMC, to complete the installation of the OpenBMC on the BMC, it is necessary to develop the installation method of the corresponding version of OpenBMC into the corresponding target image installation program and send the target image installation program to the conventional BMC for execution.

A conventional BMC image installation method is to divide a Flash on the BMC into different spaces according to space division of the BMC, such as a Boot area (approximately 1024 KB); a CONF area (2048 KB); an EXTLOG area (approximately 10240 KB); and a ROOT area and an OSIMAGE area without mandatory specific size limitations. However, the OpenBMC changes the above partitioning mechanism by directly writing the OpenBMC image into the Flash.

Therefore, logic for generating the target image installation program in step S1 needs to be formulated based on the installation method of the OpenBMC.

Further, in step S2, after the target image installation program runs on the BMC, the OpenBMC image is sent to the BMC. Then, the target image installation program is invoked to write the OpenBMC image into the Flash on the BMC. Finally, rebooting is performed, and the OpenBMC is loaded from the Flash to complete the installation of the OpenBMC image.

In some implementations of this disclosure, the step of a target image installation program is generated based on an installation method of a target image, and the target image installation program is sent to a target device includes:
based on a current image of the target device, the target image installation program is embedded into the current image to generate a temporary image; and
the temporary image is sent to the target device and installing the temporary image onto the target device through an image system currently running on the target device.

In this embodiment, the current image refers to an image corresponding to the BMC system that is currently running on the BMC of a server, namely, an image stored in the Flash on the BMC. For example, information of the BMC system currently running on the BMC is acquired, and the corresponding BMC image is acquired based on the information of the BMC system. Then, the target image installation program is embedded into the BMC image corresponding to the system currently running on the BMC of the server to generate a new BMC image, namely, the temporary image. The temporary image is also the BMC image, but differs in that the temporary image includes the target image installation program. After the image is run on the BMC, the installation of the OpenBMC image can be supported.

The temporary image with the target image installation program is sent to the running BMC. Since the temporary image is essentially also a BMC image file, a BMC running a conventional BMC image system may install the temporary image onto the BMC. Meanwhile, embedding the target image installation program into the BMC is achieved. At the same time, the method may be used to upgrade BMCs on a large batch of servers, that is, the temporary image may be sent to the plurality of BMCs, thereby allowing the plurality of BMCs to simultaneously install the temporary image with the target image installation program.

In some implementations of this disclosure, the step of in response to the execution of the target image installation program, the target image is sent to the target device includes:
based on a file format of the current image, a file format of the target image is packaged into the same file format as the current image, and a packaged target image file is sent to the target device.

In this embodiment, since the BMC image format supported by the BMC system is a format of an HP NewWave EMM text file (HPM), which is a text file format, some BMC systems do not support uploading image files in other formats, and the format of an OpenBMC image file is MTD, the OpenBMC image cannot be directly uploaded to a system corresponding to the BMC image in some cases. The OpenBMC image file in the MTD format needs to be first packaged into the HPM format, and then the OpenBMC image file in the HPM format is uploaded to the BMC running conventional BMC images.

In some implementations of this disclosure, the step of the target image is installed onto the target device through the target image installation program includes:
based on the file format of the current image, the received image file is parsed through the target image installation program to obtain an identification code and a core file, and it is confirmed that the target image is correct through the identification code; and
in response to confirming that the version of the target image file is not the target image based on the identification code, the target image installed based on an installation method of the current image.

In this embodiment, after the image file in the HPM format is received (from the perspective of the program, it is unable to confirm whether the image file is the OpenBMC image file or the BMC image file), the image file is parsed according the target image program in the HPM format to obtain the corresponding OpenBMC image file and the corresponding core file is found, namely, a bin file, as well as the identification code component ID that identifies whether the image file is the OpenBMC image file or the BMC image file. Whether the parsed image file is the OpenBMC image is determined through the value of the component ID. If the parsed image file is not the OpenBMC image, the image file is installed using the BMC image installation method.

In some implementations of this disclosure, the method further includes:
in response to confirming that the version of the image file is the target image based on the identification code, the core file is converted into a predetermined format used by the current image, and the converted core file and other files in the target image are written into a main memory and/or a backup memory based on a write method of the current image.

In this embodiment, if it is determined that the image file is the OpenBMC image based on the value of the identification code, the bin file is converted into a file in a bmc.ima format through the target image installation program. Then, the image file is written into the Flash according to a write method of the BMC image. If there are two Flashes on the BMC, the OpenBMC image may be written to one or both of the Flashes as needed.

In some implementations of this disclosure, the method further includes:
in response to confirming that the version of the image file is the target image based on the identification code, the size of the target image is modified to a predetermined value before writing the target image.

In this embodiment, before writing the OpenBMC image according to the write method of the BMC image, it is necessary to modify the size of the written image, that is, the offset of Flash write data is set to 0x0000000, the image size is set to 0x4000000 (64M), and then the image file is cyclically written into a Flash chip for upgrade.

In some implementations of this disclosure, the method further includes:
in response to the completion of writing the target image into the memory, the target device is rebooted and a predetermined register is set, such that the target device loads both a boot program and a kernel program of the target image from the same memory.

In this embodiment, after the OpenBMC image is written into the Flash through the target image installation program, the BMC is rebooted, and then the register that controls the BMC to load the Flash image is set, such that both the Uboot (the boot program) and the kernel are booted from one Flash, which may be a backup Flash or a main Flash.

In some implementations of this disclosure, the method further includes:
a running status of the boot program and the kernel program are monitored, and in response to abnormal operation of the boot program and/or the kernel program, and the memory that stores the image is switched to reboot the target device after waiting for a predetermined time.

The rebooting process is monitored through the target image installation program. If an abnormality occurs in a Uboot guiding stage or a kernel loading stage during the rebooting process, and the abnormal time exceeds 10 minutes, the BMC is rebooted, and the Flash where the image is written is switched.

In some implementations of this disclosure, the method further includes:
in response to the image system of the target device being the target image and an image to be installed being the current image, the current image is created in a compressed format using a first predetermined method, the current image in the compressed format is written to the backup memory through the target image, and an image loading path of the target device is switched to the backup memory to reboot the target device.

In this embodiment, if the system image currently running on the BMC is the OpenBMC image and an image to be upgraded is the BMC image, a method through a shell script is to create the BMC image into a TAR-form compressed package and write the TAR-form BMC image to the Flash through an upgrade interface of the OpenBMC. Then, the BMC is rebooted and switched to the Flash where the BMC image is stored for booted.

In some implementations of this disclosure, the method further includes:
in response to the target device booting from the backup memory, the current image is written in the backup memory to the main memory through a rollback function.

In this embodiment, if booting from the Flash storing the BMC image is successful, meaning the BMC image booted from the Flash runs successfully, and there are two Flashes storing the BMC image, the other Flash may also be flashed with the BMC image through the rollback function on the BMC, thereby achieving an upgrade from the OpenBMC to the BMC.

Embodiment:
(1) Add a new HPM packaging rule to support packaging an OpenBMC image into an HPM format file.
(2) Utilize a self-upgrade logic of a BMC to upload the HPM file generated in step (1) through methods such as a Web and a redfish interface.
(3) Parse the HPM file to obtain an image Bin file and component ID corresponding to an OpenBMC, and distinguish whether it is an upgrade for the BMC or the OpenBMC through the componentID.
(4) When upgrading the BMC to the OpenBMC, convert the image Bin file to bmc.ima, set the offset to 0x0000000, set the image size to 0x4000000 (64M), and cyclically write the file to flash chips to upgrade both flashes (a dual-image mode: flash0 and flash1) simultaneously.
(5) After writing is complete, reboot the BMC to keep Uboot and Kernel consistent and boot from a backup flash.
(6) If the backup flash 1 fails in booting and still fails in booting after waiting for 10 minutes, switch to the other flash0 to boot.
(7) After successful booting, enter an OpenBMC system, and complete the upgrade.
(8) When upgrading the OpenBMC to the BMC, create the BMC image to a TAR package to through a shell script, such that a BMC system may be upgraded into the backup flash through a self-upgrade interface of the OpenBMC, then, the system is rebooted and switched to the backup flash1 to be booted, and after successful booting, enter the BMC system, then use the rollback function to refresh the other flash0, and complete the upgrade.

According to the BMC heterogeneous upgrading method provided by this disclosure, the corresponding installation program is generated based on the installation method of the OpenBMC, the installation program for installing the OpenBMC is implanted into the BMC image as the new image, and the current image on the BMC is replaced with the new image, thereby allowing the conventional BMC to support installation of the OpenBMC image. The BMC image is upgraded in reverse through the upgrade interface of the OpenBMC, thereby achieving the heterogeneous upgrade between the BMC and the OpenBMC, and implementing remote upgrades from the BMC to the OpenBMC for a large number of servers. The problem that the efficiency is low during the upgrade from the BMC to the OpenBMC currently is solved.

As shown in FIG. 2, another aspect of this disclosure further provides a BMC heterogeneous upgrading system, including:
an initialization module 1, configured to generate a target image installation program based on an installation method of a target image, and send the target image installation program to a target device; and
an execution module 2, configured to send, in response to the execution of the target image installation program, the target image to the target device, and install the target image onto the target device through the target image installation program.

In some implementations of this disclosure, the initialization module 1 is configured to:
embed, based on a current image of the target device, the target image installation program into the current image to generate a temporary image; and
send the temporary image to the target device and install the temporary image onto the target device through an image system currently running on the target device.

In some implementations of this disclosure, the execution module 2 is configured to:
package, based on a file format of the current image, a file format of the target image into the same file format as the current image, and send a packaged target image file to the target device.

In some implementations of this disclosure, the execution module 2 is configured to:
parse, based on the file format of the current image, the received image file through the target image installation program to obtain an identification code and a core file, and confirm that the target image is correct through the identification code; and
install, in response to confirming that the version of the target image file is not the target image based on the identification code, the target image based on an installation method of the current image.

In some implementations of this disclosure, the execution module 2 is configured to:
convert, in response to confirming that the version of the image file is the target image based on the identification code, the core file into a predetermined format used by the current image, and write the converted core file and other files in the target image into a main memory and/or a backup memory based on a write method of the current image.

In some implementations of this disclosure, the execution module 2 is configured to:
modify, in response to confirming that the version of the image file is the target image based on the identification code, the size of the target image to a predetermined value before writing the target image.

In some implementations of this disclosure, the execution module 2 is configured to:
reboot, in response to the completion of writing the target image into the memory, the target device and set a predetermined register, such that the target device loads both a boot program and a kernel program of the target image from the same memory.

In some implementations of this disclosure, the execution module 2 is configured to:
monitor a running status of the boot program and the kernel program, and in response to abnormal operation of the boot program and/or the kernel program, switch the memory that stores the image to reboot the target device after waiting for a predetermined time.

In some implementations of this disclosure, the execution module 2 is configured to:
create, in response to the image system of the target device being the target image and an image to be installed being the current image, the current image in a compressed format using a first predetermined method, write the current image in the compressed format to the backup memory through the target image, and switch an image loading path of the target device to the backup memory to reboot the target device.

In some implementations of this disclosure, the execution module 2 is configured to:
write, in response to the target device booting from the backup memory, the current image in the backup memory to the main memory through a rollback function.

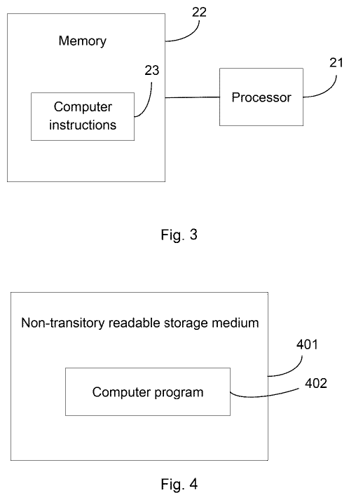

As shown in FIG. 3, another aspect of this disclosure further provides a computer device, including:
at least one processor 21; and
a memory 22, where the memory 22 stores computer instructions 23 executable on the processor 21, and the instructions 23, when executed by the processor 21, implement a BMC heterogeneous upgrading method, including:
a target image installation program is generated based on an installation method of a target image, and the target image installation program is sent to a target device; and
in response to the execution of the target image installation program, the target image is sent to the target device, and the target image is installed onto the target device through the target image installation program.

In some implementations of this disclosure, the target image installation program is generated based on an installation method of a target image, and the target image installation program is sent to a target device includes:
based on a current image of the target device, the target image installation program is embedded into the current image to generate a temporary image; and
the temporary image is sent to the target device and installing the temporary image onto the target device through an image system currently running on the target device.

In some implementations of this disclosure, in response to the execution of the target image installation program, the target image is sent to the target device includes:
based on a file format of the current image, a file format of the target image is packaged into the same file format as the current image, and a packaged target image file is sent to the target device.

In some implementations of this disclosure, the target image is installed onto the target device through the target image installation program includes:
based on the file format of the current image, the received image file is parsed through the target image installation program to obtain an identification code and a core file, and it is confirmed that the target image is correct through the identification code; and
in response to confirming that the version of the target image file is not the target image based on the identification code, the target image is installed based on an installation method of the current image.

In some implementations of this disclosure, the method further includes:
in response to confirming that the version of the image file is the target image based on the identification code, the core file is converted into a predetermined format used by the current image, and the converted core file and other files in the target image are written into a main memory and/or a backup memory based on a write method of the current image.

In some implementations of this disclosure, the method further includes:
in response to confirming that the version of the image file is the target image based on the identification code, the size of the target image is modified to a predetermined value before writing the target image.

In some implementations of this disclosure, the method further includes:
in response to the completion of writing the target image into the memory, the target device is rebooted and a predetermined register is set, such that the target device loads both a boot program and a kernel program of the target image from the same memory.

In some implementations of this disclosure, the method further includes:
a running status of the boot program and the kernel program are monitored, and in response to abnormal operation of the boot program and/or the kernel program, the memory that stores the image is switched to reboot the target device after waiting for a predetermined time.

In some implementations of this disclosure, the method further includes:
in response to the image system of the target device being the target image and an image to be installed being the current image, the current image is created in a compressed format using a first predetermined method, writing the current image in the compressed format is written to the backup memory through the target image, and switching an image loading path of the target device is switched to the backup memory to reboot the target device.

In some implementations of this disclosure, the method further includes:
in response to the target device booting from the backup memory, the current image is written in the backup memory to the main memory through a rollback function.

As shown in FIG. 4, another aspect of this disclosure further provides a non-transitory computer readable storage medium 401. The non-transitory computer readable storage medium 401 stores a computer program 402, and the computer program 402, when executed by a processor, implements the steps of the method according to any one of the above implementations.

The above contents are exemplary embodiments disclosed in this disclosure, but it should be noted that various changes and modifications may be performed without departing from the scope disclosed in the embodiments of this disclosure defined by the claims. Functions, steps, and/or actions of the method claims of the disclosed embodiments described here do not need to be performed in any specific order. In addition, although elements disclosed in the embodiments of this disclosure may be described or required individually, more elements may also be understood, unless clearly limited as the singular form.

It should be understood that the singular form “one” used here is also intended to include a plural form, unless the context clearly supports an exception. It should also be understood that “and/or” used herein refers to any and all possible combinations of one or more of items listed in association.

The disclosed embodiment serial numbers of the embodiments of this disclosure are for descriptive purposes only and do not represent superiority or inferiority of the embodiments.

Those of ordinary skill in the art should understand that all or some of the steps of the above embodiments may be implemented by hardware, or may also be completed by a program instructing relevant hardware. The program may be stored in a non-transitory computer readable storage medium. The above-mentioned non-transitory computer readable storage medium may be a read-only memory, a magnetic disk, or an optical disk, etc.

Those of ordinary skill in the art should understand that the discussion about any above embodiment is exemplary and is not intended to imply that the scope (including the claims) of the disclosure of the embodiments of this disclosure is limited to these examples; and under the idea of the embodiments of this disclosure, technical features in the above embodiments or in different embodiments may also be combined while many other changes of different aspects in the above embodiments of this disclosure exist, and for brevity, are not provided in detail. Therefore, any omission, modification, equivalent substitution, improvement, etc., made within the spirit and principle of the embodiments of this disclosure shall fall within the scope of protection of the embodiments of this disclosure.

1. A method for upgrading BMC heterogeneous, comprising:
generating a target image installation program based on an installation method of a target image, and sending the target image installation program to a target device; and
sending, in response to the execution of the target image installation program, the target image to the target device, and installing the target image onto the target device through the target image installation program.

2. The method according to claim 1, wherein the generating a target image installation program based on an installation method of a target image, and sending the target image installation program to a target device comprises:
embedding, based on a current image of the target device, the target image installation program into the current image to generate a temporary image.

3. The method according to claim 2, wherein the generating a target image installation program based on an installation method of a target image, and sending the target image installation program to a target device comprises:
sending the temporary image to the target device and installing the temporary image onto the target device through an image system currently running on the target device.

4. The method according to claim 1, wherein the sending, in response to the execution of the target image installation program, the target image to the target device comprises:
packaging, based on a file format of the current image, a file format of the target image into the same file format as the current image.

5. The method according to claim 4, wherein the sending, in response to the execution of the target image installation program, the target image to the target device comprises:
sending a packaged target image file to the target device.

6. The method according to claim 1, wherein the installing the target image onto the target device through the target image installation program comprises:
parsing, based on the file format of the current image, the received image file through the target image installation program to obtain an identification code and a core file, and confirming that the target image is correct through the identification code.

7. The method according to claim 6, wherein the installing the target image onto the target device through the target image installation program comprises:
installing, in response to confirming that the version of the target image file is not the target image based on the identification code, the target image based on an installation method of the current image.

8. The method according to claim 6, further comprising:
converting, in response to confirming that the version of the image file is the target image based on the identification code, the core file into a predetermined format used by the current image.

9. The method according to claim 6, further comprising:
writing the converted core file and other files in the target image into a main memory and/or a backup memory based on a write method of the current image.

10. The method according to claim 8, further comprising:
modifying, in response to confirming that the version of the image file is the target image based on the identification code, the size of the target image to a predetermined value before writing the target image.

11. The method according to claim 8, further comprising:
rebooting, in response to the completion of writing the target image into the memory, the target device and setting a predetermined register, such that the target device loads both a boot program and a kernel program of the target image from the same memory.

12. The method according to claim 11, further comprising: monitoring a running status of the boot program and the kernel program.

13. The method according to claim 11, further comprising: in response to abnormal operation of the boot program and/or the kernel program, and switching the memory that stores the image to reboot the target device after waiting for a predetermined time.

14. The method according to claim 1, further comprising:
creating, in response to an image system of the target device being the target image and an image to be installed being the current image, the current image in a compressed format using a first predetermined method.

15. The method according to claim 1, further comprising: writing the current image in the compressed format to a backup memory through the target image.

16. The method according to claim 1, further comprising: switching an image loading path of the target device to the backup memory to reboot the target device.

17. The method according to claim 14, further comprising:
writing, in response to the target device booting from the backup memory, the current image in the backup memory to the main memory through a rollback function.

18. (canceled)

19. A computer device, comprising:
at least one processor; and
a memory, wherein the memory stores computer instructions executable on the processor, and the instructions, when executed by the processor, implement the steps of the method as claimed in claim 1.

20. A non-transitory computer readable storage medium, wherein the non-transitory computer readable storage medium stores a computer program, and the computer program, when executed by a processor, implements the steps of the method as claimed in claim 1.

21. The method according to claim 2, further comprising:
the target device is a baseboard management controller, BMC, device running a conventional BMC system, the target image is an OpenBMC image, the current image refers to an image corresponding to the BMC system that is currently running on the BMC of a server.
